(19) United States
(12) Patent Application Publication
(10) Pub. No.: US 2003/0046157 A1
(43) Pub. Date: Mar. 6, 2003

(54) Method and system for providing incentive award information to a customer

(75) Inventor: Thomas Joseph Prorock, Raleigh, NC (US)

Correspondence Address: BRACEWELL & PATTERSON, L.L.P., INTELLECTUAL PROPERTY LAW, P.O. BOX 969, AUSTIN, TX, 78767-0969, US

(73) Assignee: International Business Machines Corp., Armonk, NY

(21) Appl. No.: 09/943,941

(22) Filed: Aug. 31, 2001

(51) Int. Cl. G06F 17/60

(52) U.S. Cl. 705/14; 705/26

(57) ABSTRACT

A method and system for providing incentive award information to a customer are disclosed. Initially, customer information of a customer is obtained from an input device. The customer information is then transmitted to a remotely located host computer. In response to the customer information at the host computer, the host computer retrieves incentive award information associated with the customer information and then transmits the retrieved information to the input device. The incentive award information is subsequently displayed on the input device. In response to scanning of a product on the input device by the customer, the product having an associated award, incentive award information of the customer is updated with the addition of the new product code. The updated incentive award information is then displayed on the input device. The customer is alerted when the updated incentive award information reaches or falls within a predetermined threshold from an award plateau.

### BACKGROUND OF THE INVENTION

1. Technical Field

The present invention relates to systems for facilitating retail transactions in general, and in particular to an electronic system for facilitating point-of-sale retail transactions. Still more particularly, the present invention relates to a method and system for providing incentive award information to a customer.

2. Description of the Prior Art

Generally, retail stores compete with each other to establish store loyalty from their customers. One method to establish store loyalty is by awarding customers some incentive points based on the accumulative amount of their purchases. Such incentive points might qualify a customer for certain discounts or other promotions in a manner similar to airlines awarding frequent-flyer mileage points. Customer transaction information, such as purchase history of each customer, is typically maintained in order to tally the incentive points that should be awarded to a particular customer based on the accumulative purchases of the customer over a certain period of time.

There are many types of point-of-sale (POS) systems that assist retailers with rewarding customer loyalty in a non-coupon environment. In a POS system that employs magnetic cards and card readers, retailers provide each of their customers with an account card that is to be presented at the POS for receiving a retailer-determined discount on goods and services the retailers sell. With such POS system, a customer typically obtains a discount by receiving a cash value equal to a portion of the amount of the purchase. The cash value is not given directly to the customer but is added to an existing cash value stored in the customer's account that can only be accessed at established intervals. The problem with such POS system is that it is very restrictive because it does not allow the customer to have immediate access to the discount. Moreover, a customer does not know his/her accumulated award points and how the award points are related to any award level until the customer arrived at the checkout counter.

Consequently, it is desirable to provide an improved system for providing incentive award information to a customer.

### SUMMARY OF THE INVENTION

In accordance with a preferred embodiment of the present invention, customer information of a customer is initially obtained from an input device. The customer information is then transmitted to a remotely located host computer. In response to the customer information at the host computer, the host computer retrieves incentive award information associated with the customer information and then transmits the retrieved information to the input device. The incentive award information is subsequently displayed on the input device.

In response to scanning of a product on the input device by the customer, the product having an associated award, incentive award information of the customer is updated with the addition of the new product code. The updated incentive award information is then displayed on the input device. The customer is alerted when the updated incentive award information reaches or falls within a predetermined threshold from an award plateau.

All objects, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of an incentive points tracking device, in accordance with a preferred embodiment of the present invention;

FIG. 2 is a block diagram of a host computer system, in accordance with a preferred embodiment of the present invention; and

FIG. 3 is a high-level logic flow diagram of a method for providing incentive award information to a customer, in accordance with a preferred embodiment of the present invention.

### DETAILED DESCRIPTION OF A PREFERRED EMBODIMENT

The incentive award program described herein takes place in retail outlets. A retail outlet is defined as any establishment from which a consumer may purchase goods or services, which includes stores, service establishments, and mail order outlets. Each retail outlet may include an in-store host computer system, a controller, various point-of-sale (POS) devices such as cash registers, etc.

A customer may enroll in the incentive award program at a service desk of a retail outlet. During the enrollment process, the customer is issued a customer identification (ID) card. The customer ID card may have a barcode and/or a read-only magnetic strip. Customer information, such as customer ID number, are stored in the barcode and/or magnetic strip. The customer ID number preferably includes a persistent six digit International Standards Organization (ISO) number and a check digit. The customer's account for the incentive award program is activated automatically when the customer ID card is being used for the first time.

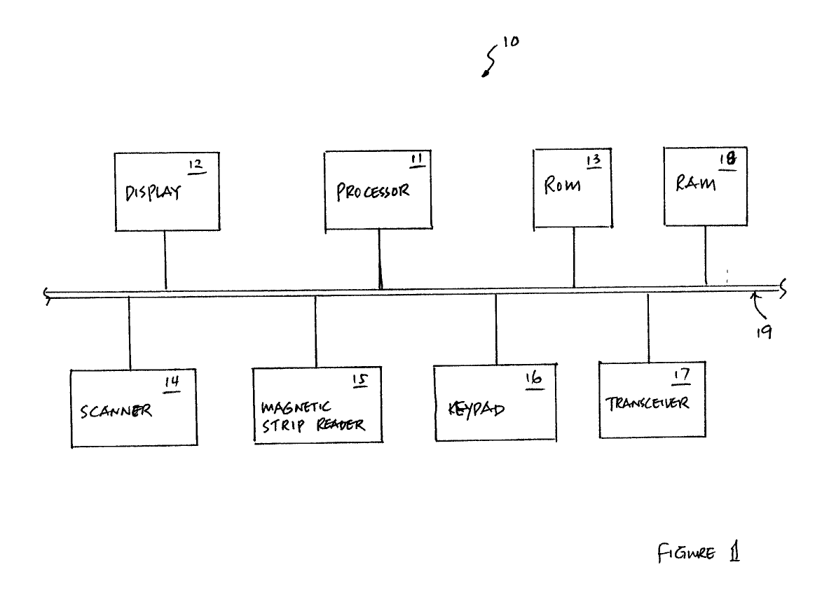

A customer typically uses a shopping tray or a shopping cart when shopping at a retail outlet such as a supermarket. Preferably, each shopping tray or shopping cart in the supermarket is equipped with a battery-operated incentive points tracking (IPT) device. Referring now to the drawings and in particular to FIG. 1, there is depicted a block diagram of an IPT device, in accordance with a preferred embodiment of the present invention. As shown, an IPT device 10 includes a processor 11, a display 12, and a read-only memory (ROM) 13 and a random access memory (RAM) 18, all connected to a system bus 19. Start-up software for IPT device 10 and incentive points tracking software to be executed in processor 11 may be stored in ROM 13 in the form of firmware. Also connected to system bus 19 are various input devices such as a scanner 14, a magnetic strip reader 15, and a keypad 16. Keypad 16 can either be an alphanumeric keypad or a numeric keypad, depending on the type of information expected to be entered by the customer, required by the incentive points tracking software. Customer information, such as customer ID number, previously stored on in a barcode and/or a magnetic strip can be entered into RAM 18 via scanning of the barcode with scanner 14 or swiping of the magnetic strip through magnetic strip reader 15. Information received from any of scanner 14, magnetic strip reader 15, and keypad 16 can be wirelessly transmitted to a host computer system located remotely within the supermarket via a transceiver 17. Based on the customer ID number, a search is then performed within the host computer system for the account information of that particular customer who has been enrolled in the incentive award program. Conversely, information within the host computer system can be wirelessly transmitted to transceiver 17, and such information can be displayed on display 12. For example, after retrieving at least the customer name and the customer's current incentive point balance from a customer database based on the customer ID number, the host computer system can transmit such customer information to transceiver 17, and such customer information can subsequently be displayed on display 12.

After receiving the customer information, IPT device 10 is ready to receive information related to items that may be purchased by the customer. Such information can be entered into IPT device 10 by the customer via scanner 14 or keypad 16. For example, the customer may enter the barcode information automatically by scanning the barcode label attached on a selected product via scanner 14, or enter the barcode information manually by pressing the appropriate buttons on keypad 16. The barcode information is then wirelessly transmitted to the host computer system via transceiver 17. After receiving the barcode information, the host computer system then matches the received barcode information with other information such as price and the associated incentive points. At this point, the incentive point balance of the customer will be tentatively updated to reflect the additional incentive points. However, the incentive point balance will not be permanently updated within the host computer system until the customer has confirmed the selection of the item purchase. Accordingly, the tentative incentive point balance will be transmitted from the host computer system to IPT device 10 so the customer can realize what his/her new incentive point balance would be if he/she decided to purchase the item. In order to obtain a purchase confirmation from the customer, IPT device 10 then prompts the customer with at least the following three options:

1. confirm the scanned item for purchase

2. remove scanned item from tray

3. cancel

The customer can select the first option to confirm the intention of purchasing the scanned item. The customer can select the second option to remove a previously selected item if the customer subsequently decided not to purchase the item. The customer can select the third option when the customer decided not to purchase the item after checking the tentative incentive points balance or when the customer has inadvertently scanned an unwanted item.

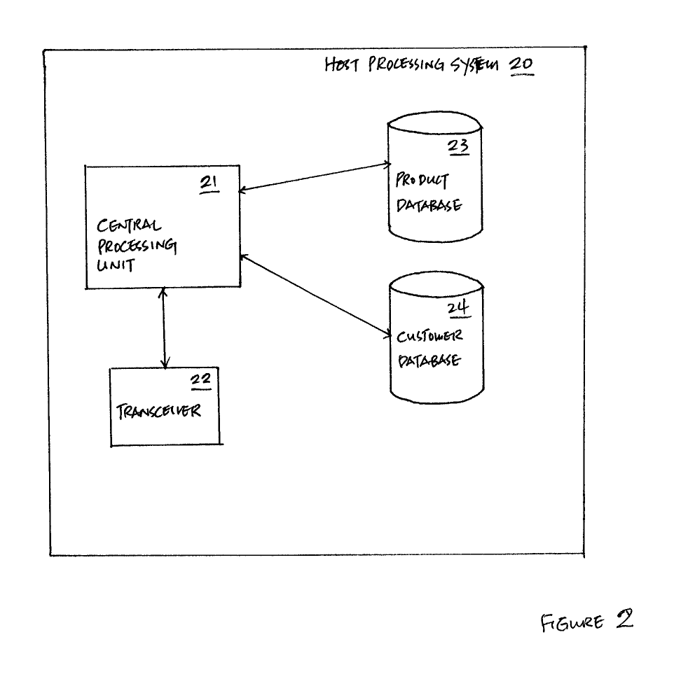

With reference now to FIG. 2, there is illustrated a block diagram of a host computer system, in accordance with a preferred embodiment of the present invention. As shown, a host computer system 20 includes a central processing unit (CPU) 21 and a transceiver 22. CPU 21 includes various components such as a processing unit, a monitor display, a keyboard, a printer, as they are well-known to those skilled in the art. CPU 21 is also associated with a product database 23 and a customer database 24. CPU 21 executes a software application that allows IPT device 10 to access product database 23 and customer database 24. An employee of the supermarket may perform various functions on host computer system 20, depending on the levels of security attached to the function and the security clearance level of the employee. The functions available for access include: balance inquiry, transfer points, point balance adjustments, point refund, merchandise order, add/change alternate identification, cancel/reissue customer ID card, enter enrollment data, and modify enrollment data.

Customer database 24 serves all real-time requests for point inquiries, updates and redemptions for consumer accounts. Customer database 24 maintains a customer file that includes consumer records for each customer that is a participant of the incentive points award program. The files within customer database 24 may include merchant records for each of the non-competing retail merchants that support the incentive points award program. Any incentive points earned by the customer via item purchase are added to the customer's current point balance stored in customer database 24 in real-time. Each customer record has the customer account data for each participating customer that includes at least data fields for storing the customer ID number and the current incentive points balance of the customer.

If the customer decided to redeem the incentive points, appropriate incentive points will be debited from the customer's incentive point balance immediately. The host computer system also includes the ability to reflect additional reductions in the price of transaction items that are determined by the retailers. Accordingly, such information will also be related to the customer via display 12 of IPT device 10 (from FIG. 1).

The host computer system may determine the award thresholds for the points of various clubs that a customer is participating in. For example, the customer may be enrolled in an Easter club, a breakfast club, a health club, and a magazine/book club. As the customer is making purchases, the incentive point program performs a check to determine if 1) the points associated with the item just purchased are close to an awards plateau and 2) if the item just purchased has reached or exceeded the award plateau. The threshold that determines the range of any approaching awards plateau may be configurable in the incentive point program. If either of the two conditions have been met, a message is displayed to the customer on display 12, alerting the customer that an award is within reach or has been exceeded and that the customer is eligible for a given incentive award. For example, when getting close to an incentive award plateau, the customer may receive any of the following prompts: “You are a $10.00 purchase away on any breakfast item to receive a free milk” or “You are a $10.00 purchase away on any paperback to receive a new magazine.” After the awards plateau has been reached or exceeded, the customer may receive the following message: “Congratulations! You have reached the shoppers club level and are eligible for a free ½ gallon ice cream during this visit.”

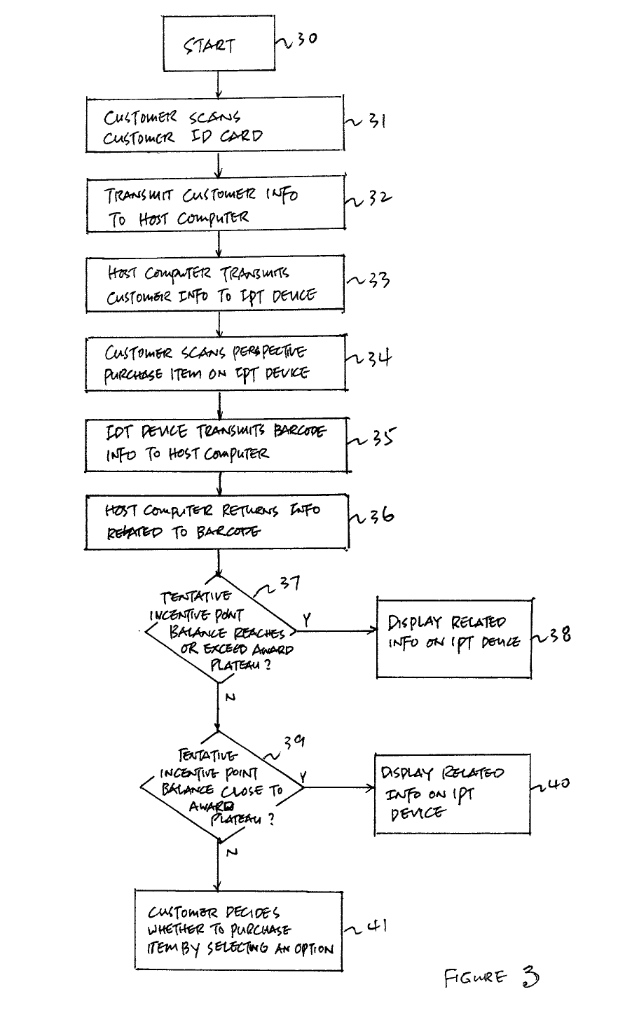

Referring now to FIG. 3, there is depicted a high-level logic flow diagram of a method for providing incentive award information to a customer, in accordance with a preferred embodiment of the present invention. Starting at block 30, customer scans a customer ID card on the scanner of an IPT device, as shown in block 31. The customer information, such as customer ID number, is then wirelessly transmitted to a remotely located host computer system, as shown in block 32. After retrieving the customer information associated with the customer ID number, such as the name of the customer, the current incentive points balance of the customer, and the award thresholds for the points clubs in which the customer is participating, the host computer system sends the customer name, the current incentive points balance, and the award thresholds to the IPT device, as depicted in block 33. At this point, the customer can begin scanning any prospective purchase item on the scanner of the IDT device, as shown in block 34. The IDT device then transmits the barcode information of the item to the host computer system in order to obtain information such as the price of the item and the incentive points value for the item, as depicted in block 35.

The host computer system accesses the item database, retrieves the price, incentive points information for the item, and tentatively updates the incentive points balance of the customer, as shown in block 36. A determination is made within the host computer system as to whether or not the tentative incentive points balance reaches or exceeds an award plateau, as depicted in block 37. If yes, the host computer system transmits such information to the IPT device to be displayed on the display of the IPT device to notify the customer that the customer have reached an award plateau and are eligible for special item or promotion, as depicted in block 38. Otherwise, another determination is made as to whether or not the tentative incentive points associated with the item just purchased are close to an awards plateau, such as the tentative incentive points fall within a predetermined range, as shown in block 39. If yes, the host computer system transmits such information to the IPT device to be displayed on the display of the IPT device to notify the customer that the customer's incentive points are very close to an award(s), and the purchase(s) of certain item(s) or dollar amount will make the customer eligible for an award, as depicted in block 40. The items that qualify the customer to the award are also displayed along the above-mentioned message so the customer is aware of what items need to be purchased. At this point, the customer can decide a purchase by selecting one of the previously mentioned three options, as shown in block 41.

As has been described, the present invention provides an improved method for providing incentive award information to a customer. The present invention allows the customer to be informed immediately following each transaction of his or her incentives earned and used in that transaction. The present invention also inform the customer of his or her new unused incentives accumulated.

While the invention has been particularly shown and described with reference to a preferred embodiment, it will be understood by those skilled in the art that various changes in form and detail may be made therein without departing from the spirit and scope of the invention.

What is claimed is:

1. A method for providing incentive award information to a customer, said method comprising:
obtaining customer information of a customer from an input device;
transmitting said customer information to a remotely located host computer;
in response to said customer information at said host computer, retrieving and transmitting incentive award information associated with said customer information from said host computer to said input device;
displaying said incentive award information on said input device;
in response to scanning of a product on said input device by said customer, said product having an associated award, updating incentive award information of said customer with the addition of said new product code;
displaying said updated incentive award information on said input device; and
alerting said customer in response to said updated incentive award information reaches a predetermined threshold from an award plateau.

2. The method of claim 1, wherein said input device is a portable input device.

3. The method of claim 1, wherein said method further includes a step of alerting said customer in response to said updated incentive award information falls within a predetermined range from an award plateau.

4. The method of claim 1, wherein said method further includes a step of confirming a purchase of said product by said customer by selecting one of a plurality of options.

5. A system for providing incentive award information to a customer, said system comprising:
means for obtaining customer information of a customer from an input device;
means for transmitting said customer information to a remotely located host computer;
means for retrieving and transmitting incentive award information associated with said customer information from said host computer to said input device, in response to said customer information at said host computer;
means for displaying said incentive award information on said input device;
means for updating incentive award information of said customer with the addition of said new product code, in response to scanning of a product on said input device by said customer, said product having an associated award;
means for displaying said updated incentive award information on said input device; and
means for alerting said customer in response to said updated incentive award information reaches a predetermined threshold from an award plateau.

6. The system of claim 5, wherein said input device is a portable input device.

7. The system of claim 5, wherein said system further includes a means for alerting said customer in response to said updated incentive award information falls within a predetermined range from an award plateau.

8. The system of claim 5, wherein said system further includes a means for confirming a purchase of said product by said customer by selecting one of a plurality of options.
